(19) United States
(12) Patent Application Publication
(10) Pub. No.: US 2008/0158327 A1
(43) Pub. Date: Jul. 3, 2008

(54) Portable system for large area printing

(75) Inventor: Robert P. Siegel, Rochester, NY (US)

Correspondence Address: RAIN MOUNTAIN LLC, 951 PARK AVE., ROCHESTER, NY, 14610, US

(73) Assignee: Robert P. Siegel, Rochester, NY (US)

(21) Appl. No.: 11/648,928

(22) Filed: Jan. 3, 2007

(51) Int. Cl. B41J 2/00

(52) U.S. Cl. 347/110

(57) ABSTRACT

A portable printing system and method comprising a temporary framework set up to support a number of scanning, printing and finishing operations, all precisely controlled by a computing device which combines a stored representation of the desired image with the specific requirements of the target area to produce a final image upon the target surface such as a wall or ceiling or other large area. The system contains a number of extendable structural elements, a specially adapted printing head and drive system with suitable ink capacity and range of motion for the application of large images, one or more distance sensors and the required software programs needed to combine these elements into the formation of a finished image upon the target surface. Base primers, profiling of the target surface and finishing operations to improve durability and surface finish can be used to improve the quality of the finished product.

### BACKGROUND OF THE INVENTION

1. Field of the Invention

This disclosure relates generally to printing systems and, in particular, to a portable printing system for large areas that can be set up to print digital images on interior walls and ceilings of buildings and other manmade structures.

2. Background

Decoration of walls and ceilings are generally limited to a uniform paint application that is brushed, rolled or sprayed on or wallpaper which generally has a repetitive pattern. Those seeking a more pictorial treatment always have the option of hiring a painter to paint a mural, though this can be quite costly. Stenciling is another option, though, like wallpaper, it is generally applied in a repeating pattern.

With the onset of digital technology and digital printing in particular, new opportunities now exist for the application of detailed images on a variety of different surfaces and substrates. There are several limitations, of course, and these are generally with respect to the type of surface being printed on (the substrate) and the mechanical alignment between the print mechanism and the surface that will be receiving the image.

A wide variety ink jet printing devices have been described. Examples of such devices are found in U.S. Pat. Nos. 3,512,173; and 4,074,284 which described inkjets printers with removable print heads.

Several different methods have been used to eject the droplets.

U.S. Pat. No. 4,504,845 issued Mar. 12, 1985 to Erich Kattner describes a piezo-electric ink jet printer, where a piezo tube is used to drive the ink through a plurality of hollow tubes.

U.S. Pat. No. to 4,612,554 Michael Poleshuk on Sep. 16, 1986 describes a thermal ink jet printer where ink is ejected from a series of nozzles by selective application of current pulses to the heating elements in response to digitized data signals received by the printer.

U.S. Pat. No. 4,751,528 granted Jun. 14, 1988 to Charles Spherhly, et al., describes a hot-melt ink jet printer in which a solid ink made of a wax-like substance is melted then ejected onto a substrate whereupon it cools and re-solidifies. An electrical heater and a thermoelectric coolers are use to control platen temperature.

U.S. Pat. No. 3,893,623, granted to Richard A. Toupin on Jul. 8, 1975, describes an early ink jet printer where a stream of ink which is amplitude or frequency modulated to produce discrete droplets. A weir is located downstream from the jet orifice, near the point of drop formation where it contacts and deflects droplets of larger transverse diameter. The deflected droplets are caught in a gutter.

U.S. Pat. No. 4,250,510 John L. Dressler, issued Feb. 10, 1981 describes a continuous ink jet printer, wherein fluid filaments are stimulated to break up into jet drop streams directed at the fluid receiving medium. An electrically conductive catcher is used to deflect those drops not intended for the image. Drops which are not charged by the catcher means travel past the catcher means and are deposited on the fluid receiving medium. This approach allows the unused ink to be recycled, which is an important cost savings.

The question of large area printing is addressed in part by inventions such as U.S. Pat. No. 5,488,397 to Nguyen on Jan. 30, 1996. This device uses multiple printheads which move in a given scan direction to apply a swath of images to media which is periodically advanced in a media feed direction. In this case as in all the others above, the printhead scans across while the media is advanced perpendicular to the scan direction.

Murray, U.S. Pat. No. 5,686,947, issued Nov. 11, 1997 describes a large format ink jet printer with a large ink reservoir mounted inside the housing of the ink jet printer at a location which is remote from the ink jet cartridge and tubing connecting the ink reservoir to the ink jet cartridge. The large ink reservoirs may be stacked in side by side horizontal manner within the housing.

Robertson, U.S. Pat. No. 5,751,319 May 12, 1998 describes a system where an ink cartridge can be automatically replenished from a reservoir.

U.S. Pat. No. 6,180,228 to Bruno Mueller Jan. 30, 2001, describes an outdoor advertising system, where a multi-layer substrate is used to attach to a sidewalk or a road surface upon which images can be printed. The printed layer is then covered by a transparent protective layer.

Obviously, there is still a need for a portable printing system for large areas that can be set up to print digital images on interior walls and ceilings of buildings and other manmade structures.

### SUMMARY OF THE INVENTION

Accordingly, the Portable System for Large Area Printing described herein is intended specifically for applying images to large flat surfaces such as those found in buildings. The system consists of a specialized set of inks and primers developed for this purpose with respect to their cost and durability, a printing head that can deliver the various colors of pigment or ink with appropriate carrier vehicle at a suitable resolution, a measurement and alignment system that is used to determine key dimensional characteristics of the intended target surfaces and surrounding structural elements, a portable computer containing a representation of the desired image and a software program that will drive the printing head and align and scale the desired image on the target surface with respect to the key target surface dimensions, and a modular adjustable printing frame comprised of a selection of extendable frame elements to be assembled in such a way so as to rigidly support the printing head during its operation, making use of surrounding and adjacent building elements in order to do so. The intent is for a skilled technician or contractor to assemble the printer in situ in a configuration that will support the printing operation for that particular site using adjacent walls or the ceiling and floor or any combination of the above that will provide the required structural stability for the printing operation. The printing head will then be attached to the frame along a scan rail. Said technician will then perform the necessary alignment measurements including the start position of the printing head and enter parameters into the computer. The software program will then perform the appropriate alignment and scaling operations and show a preview of the finished job. If the preview is accepted, the printing operation will begin. It is further intended that the administration of this printing service be structured as a franchise operation, with franchisees obtaining equipment, materials and training from the parent company at an appropriate cost and providing said parent company a percentage of earnings in return for the use of proprietary equipment as well as the company name.

### BRIEF DESCRIPTION OF THE DRAWINGS

The foregoing and other features of the exemplary embodiments will be apparent and easily understood from a further reading of the specification, claims and by reference to the accompanying drawings in which like reference numerals refer to like elements and wherein:

FIG. 1 is a schematic front view of a typical Portable Large Area Printing System installation;

FIG. 2 is a block diagram showing the basic steps in the Portable Large Area Printing System process; and

FIG. 3 is a block diagram describing the operations performed by the Portable Large Area Printing System software.

### DETAILED DESCRIPTION OF THE INVENTION

While preferred embodiments will be described hereinafter, it will be understood that it is not intended to limit the disclosure to those embodiments. On the contrary, it is intended to cover all alternatives, modifications, and equivalents as may be included within the spirit and scope of the disclosure as defined by the appended claims.

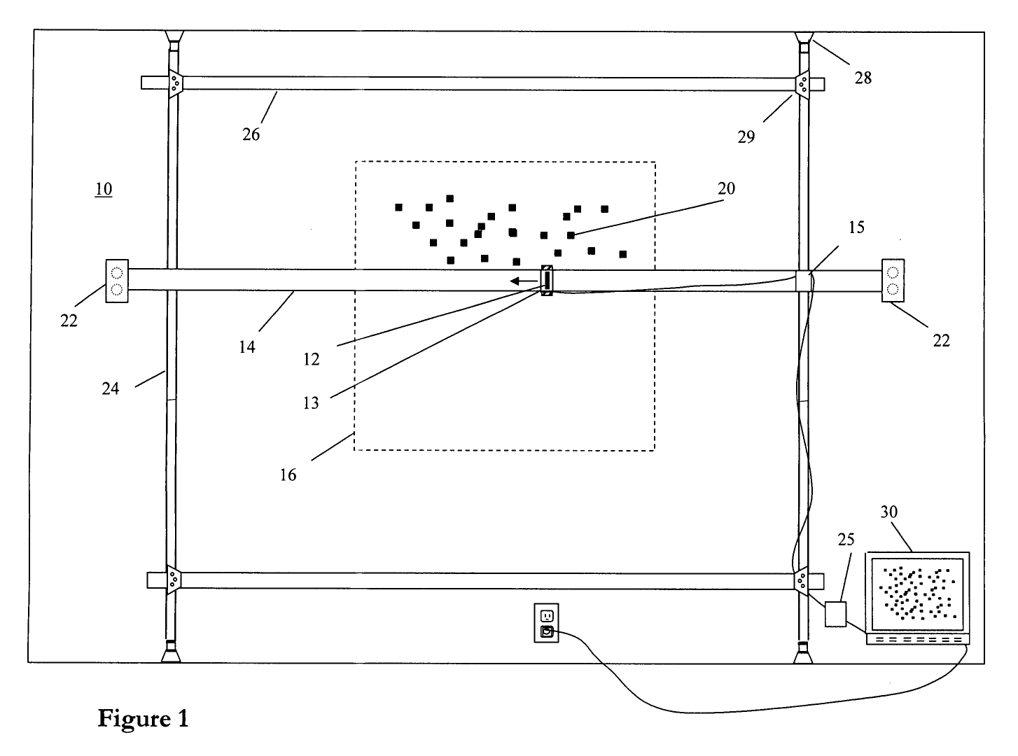

For a general understanding of the features of the exemplary embodiments, reference is made to the drawings. In the drawings, like reference numerals have been used throughout to identify identical elements. FIGS. 1-3 schematically depict various views illustrating a portable system for large area printing incorporating the features of the present invention therein. It will become evident from the following discussion that the disclosed system may be employed in a wide variety of applications for applying images to large areas and is not specifically limited in its application to the particular apparatus and method specifically mentioned herein.

Referring now to FIGS. 1-3, various views are shown illustrating the Portable System for Large Area Printing 10. In FIG. 1, a printing head 12 is supported by a scan rail assembly 14 which contains provisions to guide and transport the printing head 12 as it moves across the image target area 16 applying image 20. The scan rail assembly 14 is itself capable of motion perpendicular to the printing head motion and is driven by the scan rail drive 15. The printing operation is controlled by portable computer 30 which contains both a digital representation of the image 20 as well as software designed to control both the motion and the ink dispensing operations of the printing head. The software makes use of alignment data provided by position transducers 22. The computer 30 receives data from transducers 25 and communicates with the printing head 12 and the scan rail drive 15 through electrical interface 25. The scan rail assembly 14 is supported by a series of frame elements such as structural interface members 24 and intermediate members 26. The printing head 12 is connected to the scan rail assembly through the printhead carriage 13 upon which it rests. The structural interface members 24 interact with the structure surrounding the target surface area in such a way as to firmly and rigidly establishing itself as a temporary structure to support the printing operation. The members 24 are constructed with adjustable end caps 28 which are made of resilient material so that they can be firmly applied against adjacent walls and ceilings without causing any marks or damage. The intermediate members 26 attach to the structural interface members by means of brackets 29 to provide further rigidity to the temporary printing frame. Both the structural and the intermediate members may be horizontally or vertically or otherwise deployed depending on the circumstances of the individual situation such as the orientation of the image area and the proximity of supporting surfaces in the structure in which the image will be applied.

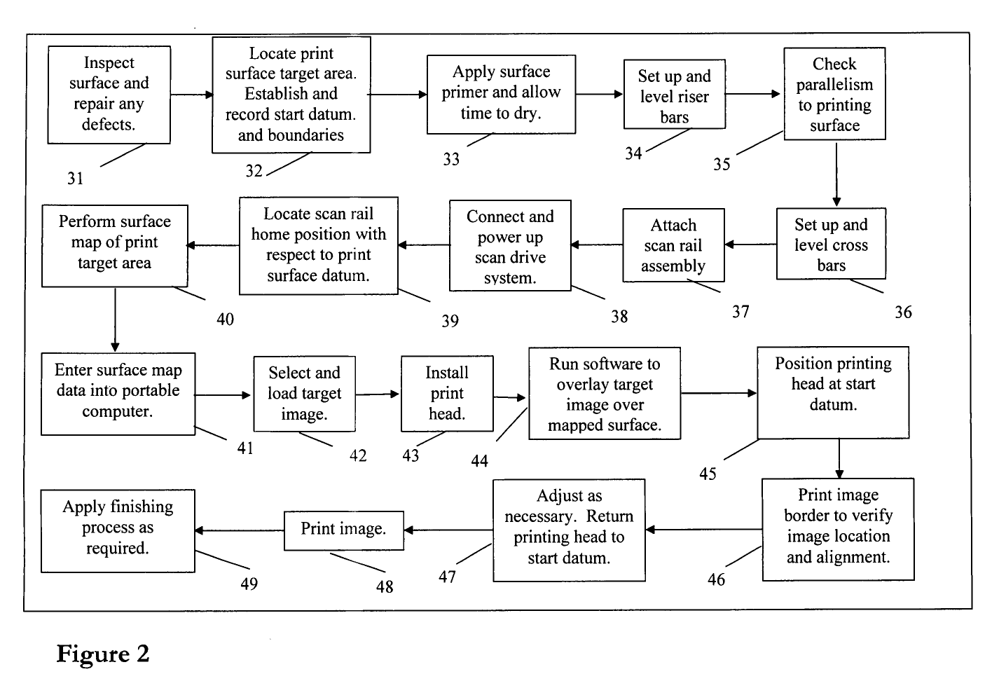

FIG. 2 is a block diagram which describes the Portable Large Area Printing process. In step 31 the installer inspects the target area and makes any repairs necessary such as patching holes, filling cracks, etc. In step 32 the image installer locates and marks the boundaries of the image target area 16. A datum is required as a reference point to establish the relationship between the coordinate system on the computer 30 and on the target area 16. Careful measurements of the target area are made and entered into the computer. In step 33 the installer applies a primer, if needed, upon which the final image will be applied. The primer, which among other things, serves as the “canvas” upon which the image will be painted, could be tinted white or black or potentially any color of the customer's choice having either a glossy or matte characteristic. Furthermore, a transparent primer could also be used which would allow the background wall or ceiling color to show through, if so desired. The primer has properties conducive to adhesion and image durability. At this point in step 34, the installer is ready to begin constructing the temporary framework that will serve as the body of the portable printer. First a set of riser bars 24 are erected parallel to the image target surface. Care is taken to ensure that these bars remain parallel to the image to the extent possible. The riser bars 24, which can be quite long, can be assembled from sections having threaded fittings at both ends, or telescoping riser bars can also be used with friction fittings to allow adjustment of the overall length. Provisions 28 such as adjustable end caps with rubber tips at the ends ensure that the riser bars are firmly located without damaging the interior surfaces upon which they are installed. Note that although they are called riser bars, they will not necessarily always be in a vertical orientation, depending upon the orientation of the target surface. If, for example the target surface is a ceiling, then the riser bars will stretch parallel to the ceiling and locate on a pair of adjacent walls at a fixed distance from the ceiling. Measuring instruments such as laser distance detectors 22 are used in step 35 to ensure that the riser bars are indeed parallel to the target surface. Adjustments are made as required. In step 36 cross bars 26 are fastened by means of brackets 29 perpendicular to the riser bars and parallel to the target area. These bars stabilize and add rigidity to the portable large area printing frame. With the frame in place, the scan rail assembly 14 can be installed in step 37. The scan rail assembly is attached to the riser bars 24 between the two cross bars 26. In step 38 the scan rail drives are connected electrically to a power source and to the computer 30 by means of the electrical interface 25 and mechanically to the printing frame by means of a drive arrangement such as a rack and pinion system or a timing belt or chain with appropriate tensioners and a track that will allow the scan rail assembly 14 to be driven along the riser bars in a computer controlled manner. At this point, in Step 39, distance sensor 22 is attached to the print head carriage 13. The printhead carriage 13 is moved until it is directly in front of the image datum point described in step 32. The position is then communicated to the computer 30, through the electrical interface 25 or through other means such as the keyboard. In step 40 the distance sensor 22 on the print head carriage 13 is used to create a map of the target surface. This is done by a scanning operation of the print carriage 13 as directed by the computer 30 through the electrical interface 25. The printing head carriage 13 makes a series and traversing scans along the scan rail assembly 14 at the end of each of which the scan rail assembly indexes upward or downward along the riser bars 24. The mapping data are communicated to the computer through the electrical interface 25 in step 41. Once the mapping is completed, the customer's selected image is loaded in step 42 into the computer through an appropriate interface such as a USB memory drive or over a wired or wireless internet connection. The image must be of sufficient resolution to provide acceptable image quality when enlarged upon the target surface. In step 43 the printing head 12 is installed on the print head carriage in place of the distance sensor 22. The print head 12 can be one of a number of printing technology types including continuous liquid ink jet or a wax type thermal ink jet. It is understood that a variety of different print media can be used, such as paint or toner or wax droplets, though for purposes of simplicity in this application, the term ink will be used. The printing head will contain or have access to ink reservoirs of sufficient volume to complete the large image. In step 44 an image processing software application is run which will map the image onto the target area. The software will provide a number of functions including image registration, scaling, correction for target area defects such as local curvature of the target surface, compensation for non-perpendicularity in the room, resolution enhancement. Additional features such as compensation for non-uniform illumination of the target surface could also be provided. Once the image processing is competed, the printing head is positioned by the driver software in step 45 and the position is verified by the image installer. The software is then employed 46 to print a faint border around the entire image target area which is again verified by the installer. Any adjustments are made in step 47 and the print head is returned to the start datum position. After positions have been checked the printing process can begin 48. The print process is implemented much in the same way as the mapping was done. The print head carriage 13 is driven along the scan rail assembly 14 applying ink according to instructions from the computer 30. At the end of each scan, the scan rail assembly 14 is indexed along the riser bars 24 and the next scan is initiated. To save time, every other scan can be down backwards to avoid having to return the carriage as one would with a typewriter. Finally, in step 49, any finishing steps required are applied. In some cases the materials package, consisting of the combination of primer and ink used to create the image could be subject to a finishing operation such as heat or pressure treatment or the application of a clear top coat that could provide a glossy or matte protective surface.

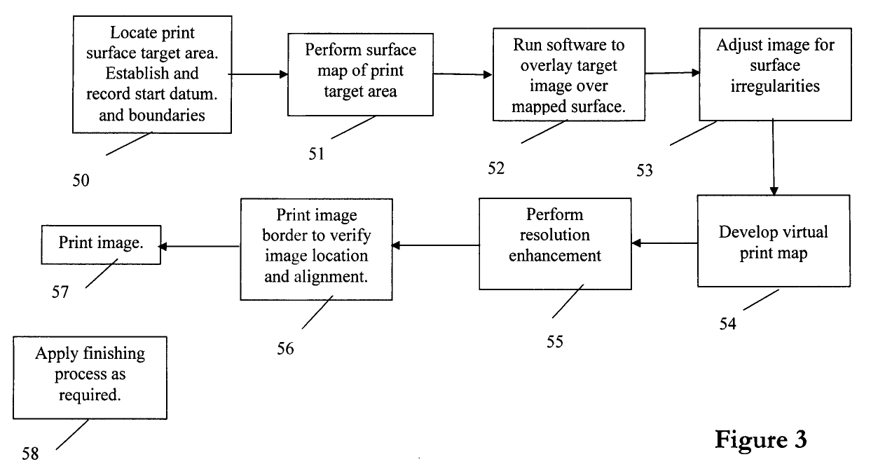

FIG. 3 is a block diagram describing the operations performed by the Portable Large Area Printing System software.

In step 50 the software is used to locate the print target area with respect to one or more physical datum points. This is used as a basis to project a virtual representation of the image upon the physical target. Once these data have been established, a two-dimensional coordinate system is developed that emanates from them. In step 51 a scanning operation is used to acquire a virtual map of the target area. This provides the software with a representation of the physical size of the target in terms of the virtual coordinate system used by the software. The map can also provide boundary information about the room itself. In many buildings, walls and ceilings are not perfectly square. Surfaces are neither perfectly vertical nor horizontal. Adjacent surfaces are not perfectly perpendicular and facing surfaces are not perfectly parallel. The map is created in 52 which gives the software program precise data from which image processing functions can be applied that can compensate for any target irregularities, by, for example, stretching or rotating the image to ensure that the edges of the completed image run parallel to the adjacent walls. In step 53 the detailed surface data of the target area is incorporated so that irregularities such as local curvatures in the wall surface can be compensated for by stretching the image over a curved section while stitching it together with its adjacent regions to provide a smooth and seamless appearance. In step 54 the software takes all of the data acquired in the previous steps and applies it to the virtual image so as to obtain a virtual print map. This includes any scaling or rotating functions, corrections for surfaces defects and so forth such that a virtual print map results which can be used to tell the computer exactly where and how to place every element of the image onto the target area. In step 55, any resolution enhancement processing is added. Since the image will be very large, it is likely that unless the digital image was of a very high resolution, some enhancement may be needed to avoid a grainy or jagged “pixilated” appearance that is common with digital images when they are displayed in a highly enlarged manner. For photographs a resolution of 120 to 200 pixels or dots per inch is commonly used. This would require an image file size of roughly 40 mega-pixels for a 3-foot by 4-foot picture or about 270 mega-pixels for an 8-foot by 10-foot picture. Because these wall pictures are to be viewed at some distance, a somewhat smaller resolution could be used satisfactorily, though the image file sizes would still be quite large, exceeding what conventional cameras are capable of by an order of magnitude or more. Resolution enhancement is an image processing technique commonly used in laser and inkjet printers to extend the effective resolution of an image, by algorithmically modifying pixel size in areas where it would be known to be beneficial, for example, when there is a curved line, smaller pixels are used to avoid a jagged appearance. The technique is also used in VLSI photolithography. An alternate way of effectively improving the resolution is to break the target image into a number of individual blocks, each of which would be of a reasonable file size, and then using the software to stitch the blocks together. This technique is already being using in digital cameras today in the so-called panorama mode. In step 56 the software can be used to drive the print head and the print head carriage to print a faint outline of the image to ensure that the image is located correctly before the complete image is laid down to avoid costly errors. In step 57 the actual printing is done. The software drives the print head carriage, the scan rail and the print head to ensure that the appropriate droplets of the appropriate colors are ejected at the appropriate locations. The print carriage speed is generally held constant with respect to the ink ejection rate, although this can be modified in curved or irregular areas so as to stretch or compress the image if so desired. Finally, in step 57 after the image has been applied to the surface, a drying and finishing operation may be applied to the image, to avoid any dripping or running of the image and to enhance the appearance and durability of the final product. A number of techniques such as heated air, radiant heat, Ultraviolet light or beamed microwave energy could be used to finish the drying process either immediately following the printing head at a fixed interval or as a separate operation after the image has been fully applied. Pressure could also be used with certain material sets to provide a more durable surface.

In recapitulation, a portable large area printing system has been described, which entails a temporary structural framework that is set up to support a number of scanning, printing and finishing operations, all precisely controlled by a computing device which combines a stored representation of the desired image with the specific requirements of the target area so as to produce a final image upon the target surface which could be a wall or a ceiling or other large areas. The system consists of a number of portable extendable structural elements, a specially adapted printing head and drive system, one or more distance sensors and the required software programs needed to combine these elements into the formation of a finished image upon the target surface.

While the invention has been described in conjunction with the specific embodiments outlined above, it is evident that many alternatives, modifications and variations will be apparent to those skilled in the art. Accordingly, the preferred embodiments of the invention as set forth above are intended to be illustrative and not limiting. Various changes may be made without departing from the spirit and scope of the invention as defined herein.

I claim:

1. A system for applying large images upon existing structural elements such as walls and ceilings, comprising:
a series of extendable modular frame elements capable of being assembled into a frame;
one or more distance sensors to be used to establish the frame location with respect to the target surface; and
a specially configured printing head and drive system with adequate ink capacity and range of motion capable of applying large images onto large areas;
a portable computing device; and
one or more software programs capable of combining the above elements with a stored representation of the desired image and controlling the operation of said elements so as to precisely apply said image onto the target area.

2. The system of claim 1, wherein a special primer coat is applied to the target surface before the image application to enhance the adhesion of the ink to the surface and to improve the durability of the resulting image.

3. The system of claim 1, wherein a moveable distance sensor is used to scan the target surface to create a surface map of the target area which can be used to customize the application of the desired image to that specific location.

4. The system of claim 1, wherein one or more finishing operations such as the application of heated or pressure or radiant energy is used to enhance the durability and surface appearance of the applied image.

5. A method of applying large images upon existing structural elements such as walls and ceilings, comprising:
providing a series of extendable modular frame elements capable of being assembled into a frame;
providing one or more distance sensors to be used to establish the frame location with respect to the target surface; and
providing a specially configured printing head and drive system with adequate ink capacity and range of motion capable of applying large images onto large areas;
providing a portable computing device; and
providing one or more software programs capable of combining the above elements with a stored representation of the desired image and controlling the operation of said elements so as to precisely apply said image onto the target area.

6. The method of claim 5, wherein a special primer coat is applied to the target surface before the image application to enhance the adhesion of the ink to the surface and to improve the durability of the resulting image.

7. The method of claim 5, wherein a moveable distance sensor is used to scan the target surface to create a surface map of the target area which can be used to customize the application of the desired image to that specific location.

8. The method of claim-5, wherein one or more finishing operations such as the application of heated or pressure or radiant energy is used to enhance the durability and surface appearance of the applied image
